(19) United States
(12) Patent Application Publication
(10) Pub. No.: US 2015/0334917 A1
(43) Pub. Date: Nov. 26, 2015

(54) Free Spinning Ball Device

(71) Applicant: Paul Michael Durden, Maryville, TN (US)

(72) Inventor: Paul Michael Durden, Maryville, TN (US)

(21) Appl. No.: 14/286,886

(22) Filed: May 23, 2014

(51) Int. Cl. A01D 34/90; A01D 34/84; B60B 33/08; A01D 34/416

(52) U.S. Cl. CPC A01D 34/902; A01D 34/416; A01D 34/84; B60B 33/08

(57) ABSTRACT

A free spinning ball device giving support to the cutting head of a string trimmer, while maintaining a plane which is parallel and vertical to the surface being cut. The lower end housing is open to allow the primary ball to maintain constant contact with the ground while unit is in operation. The upper end housing is closed with an end designed to mate with both flat and curved heads which are most commonly found on string trimmers. The upper housing has a grooved wall around the upper interior circumference to retain smaller balls, which are in continual contact with the main spinning ball during operation. The upper and lower housings are attached to each other using an integrated lock which can be turned either clockwise or counter-clockwise to match the rotation of all string trimmers.

### BACKGROUND

1. Field of the Invention

This invention is concerned with the field of string trimmers and more particularly with a free spinning ball device used to maintain a level desired cutting plane of vegetation, lessen the strain on operators by transferring weight of trimmers to the ground and especially by minimizing damage to ‘bump-feed’ type string trimmers.

2. Disclosure of Prior Art

Most people use string trimmers as cutting devices for trimming vegetation in areas not readily available to conventional lawn mowers.

Although many devices with various wheels in multiple locations and configurations, these current versions have several problems. For example, U.S. Pat. No. 5,450,715 has “a wheeled frame having a clamp arranged to be freely secured to the wand of a device for rotation of the wand therein”, this device may relieve the weight of said trimmer, however does not maintain a continual even cutting plane, parallel to the ground nor does it have a 360 degree movement. Said device also does not relieve damage to ‘bump-feed’ type string trimmer heads.

Another example, U.S. Pat. No. 6,871,484 has a two wheel support on which the trimmer rests, this device may also relieve the weight of said trimmer, however does not maintain a continual even cutting plane, parallel to the ground nor does it have 360 degree movement. Said device also does not relieve damage to ‘bump-feed’ type string trimmer heads.

Another example, U.S. Pat. No. 5,467,584 has “a stabilizing roller for a line trimmer device that includes a housing with a cylindrical bore for receiving and mating with a ball roller”, this device may also relieve the weight of said trimmer, however does not maintain a continual cutting plane, parallel to the ground. Said device also does not relieve damage to ‘bump-feed’ type string trimmer heads.

Another example, U.S. Pat. No. 7,617,661 “relates to a grass trimmer comprising a wheeled carriage”, this device may also relieve the weight of said trimmer and maintain a continual cutting plane, parallel to the ground. Said device does not have 360 degree movement, rather operating in a vacuum cleaner like movement. Said device also does not utilize a ‘bump-feed’ type head.

Another example, U.S. Pat. No. 4,419,822 has “the driving member has teeth which normally drivingly engage with an upper series of internal clutch teeth when the dome-like protrusion is ‘bumped’ on the ground, whereby discrete lengths of cutting filament are let out from the spool member”. Said device is found on many string trimmers sold for residential and commercial use, however does have a penchant for incurring damage to said teeth and internal spring when continually ‘bumped’ on the ground.

### SUMMARY OF THE INVENTION

In view of the above known stabilizing devices, this invention represents an improvement for maintaining a 360 degree movement of a string trimmer along the ground's surface, while maintaining a continual level cutting surface.

It is a further object of the present device to also reduce damage to the internal parts of existing ‘bump-feed’ type string heads by maintaining continual contact with the grounds surface while applying slight pressure downward to engage the string feed process.

It is yet a further object of the device to provide an inexpensive easily maintainable accessory to relieve the operators strain by otherwise having to carry a string trimmer for long periods of time.

### DESCRIPTION OF DRAWINGS

FIG. 1 is a side view of a typical electric or gas trimmer [1] of the type used to trim lawns and cut weeds, with an attached free spinning ball device [2] embodying the features of this invention thereon.

FIG. 2 is a side view of the free spinning ball device [2] shown in FIG. 1 comprising of the upper housing [3] and lower housing [4]. The upper housing [3] depicts the string trimmer mounting base [5] which is molded to the upper housing [4] and used to attach the free spinning ball device [2] to the string trimmer [1]. For illustration purposes, the upper housing [3] and lower housing [4] are rendered on the drawings “transparent” to reveal the enclosed main spinning ball [6] and secondary spinning balls [7].

FIG. 3 is an exploded view of the free spinning ball device [2] shown in FIG. 1 comprising of the upper housing [3] and lower housing [4], the main spinning ball [6] and the secondary spinning balls [7].

### DESCRIPTION OF PREFERRED EMBODIMENT

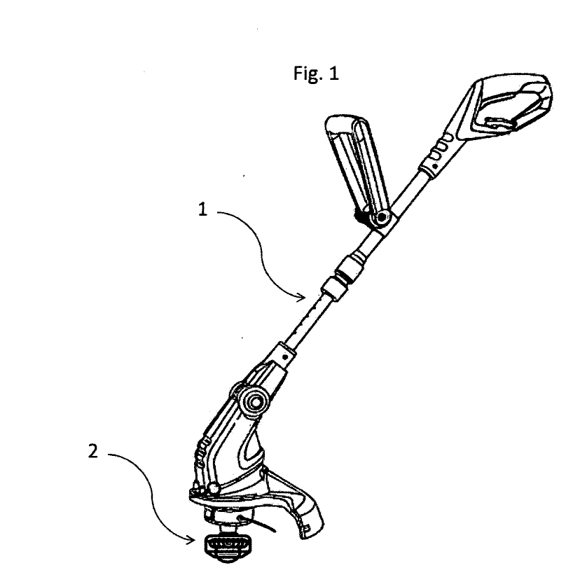

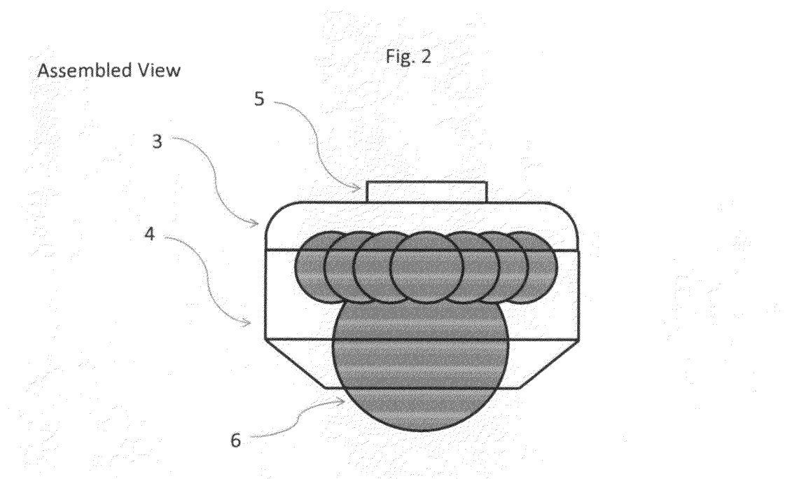

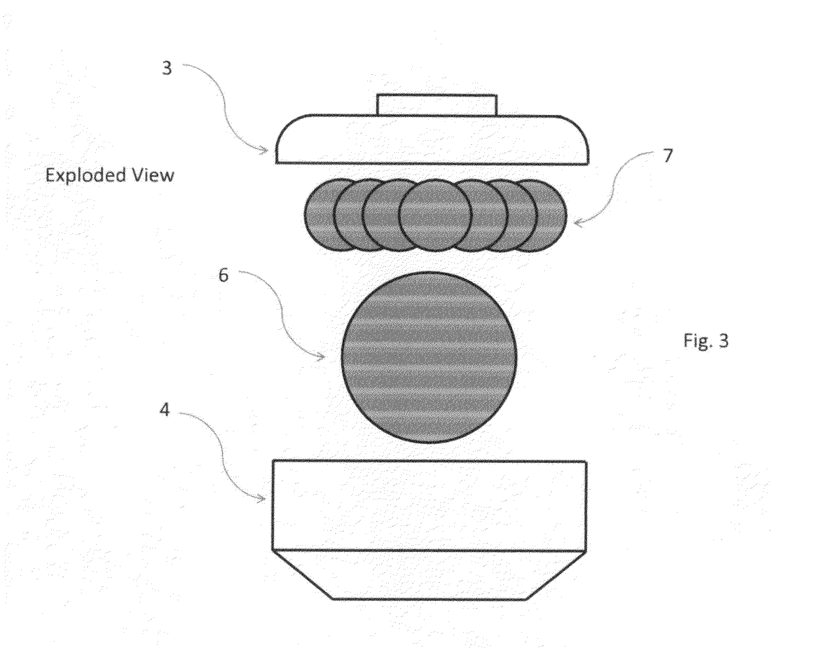

An electric or gas powered string trimmer [1] is shown in FIG. 1 of the drawings with a free spinning ball device [2] embodying the features of this invention attached to the working end of an electric or gas powered string trimmer [1] for the purpose of supporting the working end of the trimmer a specific distance above the ground for ease of use by the operator. As illustrated in FIG. 2 the free spinning ball device [2] is comprised of a upper housing [3] and lower housing [4] which is attached to the electric or gas powered string trimmer [1] by the string trimmer mounting base [5]. The string trimmer mounting base [5] is molded to the upper housing [3] and consists of a concave feature on the surface designed to attach to the electric or gas powered string trimmer [1] using standard epoxy cement. Additionally, FIG. 2 illustrates the main spinning ball [6] protruding through a hole in the lower housing [4] designed to house the main spinning ball [6] with optimum exposure to the ground surface to aid in smooth movement across the ground surface as the operator moves the electric or gas powered string trimmer [1] in a desired pattern or direction parallel to the ground surface. FIG. 3 is an exploded view of the free spinning ball device [2] illustrating the secondary spinning balls [7] which are used to nest the main spinning ball [6] internal to the upper housing [3] and lower housing [4]. The intent of the secondary spinning balls [7] is to further aid the main spinning ball [6] in free spinning motion as the main spinning ball [6] contacts the ground surface while the operator moves the electric or gas powered string trimmer [1] in a desired pattern or direction parallel to the ground surface.

To attach the free spinning ball device [2] to an electric or gas powered string trimmer [1] the operator simply applies standard epoxy cement to the concave feature of the string trimmer mounting base [5] and firmly presses the free spinning ball device [2] to the working end of the electric or gas powered string trimmer [1] as illustrated in FIG. 1.

Once a free spinning ball device [2] is attached to an electric or gas powered string trimmer [1], the string trimmer is supported on the ground surface by the free spinning ball device [2] allowing the operator to move the electric or gas powered string trimmer [1] effortlessly in a desired pattern or direction parallel to the ground surface.

What is claimed:

1. In a lawn string trimmer having a handled shaft which is easily gripped by a user, a rotating string cutting head located at the distal end of said handled shaft, attached to a motor for rotating the cutting head at a high rate of speed so as to trim various vegetative growths, in a horizontal plane above the ground, a free spinning ball device that maintains constant contact with the ground while in operation.

2. The free spinning ball device of claim 1, wherein device attached to standard string trimmers base by an epoxy cement.

3. The free spinning ball device of claim 1, wherein superior end attaching to string trimmer base is indented in center and flat on outer perimeter surface.

4. The free spinning ball device of claim 1, wherein superior end housing having an internal track running the diameter capable of retain multiple small balls.

5. The free spinning ball device of claim 1, wherein 1 (one) large ball maintains contact with all multiple smaller balls.

6. The free spinning ball device of claim 1, wherein distal housing having a hole large enough to allow enough exposure of the said large ball while still maintaining it inside.

7. The free spinning ball device of claim 1, wherein superior end housing and distal end housing are connected using an integrated locking mechanism to enable user to turn and lock clockwise or counterclockwise.
